(19) United States
(12) Patent Application Publication
(10) Pub. No.: US 2009/0170972 A1
(43) Pub. Date: Jul. 2, 2009

(54) NATURAL OIL BASED POLYOLS WITH INTRINSIC SURFACTANCY FOR POLYURETHANE FOAMING

(75) Inventors: Jean-Marie Sonney, Schindellegi (CH); Francois M. Casati, Pfaffikon (CH)

Correspondence Address: The Dow Chemical Company, Intellectual Property Section, P.O. Box 1967, Midland, MI, 48641-1967, US

(73) Assignee: Dow Global Technologies Inc., Midland, MI (US)

(21) Appl. No.: 12/294,186

(22) PCT Filed: Mar. 14, 2007
(86) PCT No.: PCT/US07/06428

§ 371 Date: Sep. 23, 2008

Related U.S. Application Data
(60) Provisional application No. 60/785,607, filed on Mar. 23, 2006.

(51) Int. Cl. C08L 75/04

(52) U.S. Cl. 521/88; 521/137; 521/94

(57) ABSTRACT

The present invention pertains to natural oil based polyols having intrinsic surfactancy and to their use in the production of flexible, viscoelastic and/or semi-rigid, one-shot polyurethane foams with reduced VOC (Volatile Organic Compound) emission.

The present invention pertains to polyols based on renewable resources having intrinsic surfactancy and to their use in the production of silicone free flexible, viscoelastic and/or semi-rigid foam.

Polyether polyols based on the polymerization of alkylene oxides, and/or polyester polyols, and/or combinations thereof, are the major components of a polyurethane system together with isocyanates. Polyols can also be filled polyols, such as SAN (Styrene/Acrylonitrile), PIPA (polyisocyanate polyaddition) or PHD (polyurea) polyols, as described in “Polyurethane Handbook”, by G. Oertel, Hanser publisher.

One class of polyols are those made from vegetable oils or renewable feedstocks. Such polyols are described by Peerman et al. in U.S. Pat. Nos. 4,423,162; 4,496,487 and 4,543,369. Peerman et al. describe hydroformylating and reducing esters of fatty acids as are obtained from vegetable oils and forming esters of the resulting hydroxylate materials with a polyol or polyamine. Higher functional polyester polyol materials derived from fatty acids are described in WO 2004/096882; WO 2004/096883. These polyester polyols are made by reacting a polyhydroxyl initiator with certain hydroxymethylated fatty acids. Others approaches for polyols based on renewable resources are described for example in Publications WO 2004/020497; WO 2004/099227; WO 2005/0176839; WO 2005/0070620 and in U.S. Pat. No. 4,640,801.

Polyurethane foams generally contain additional components such as surfactants, stabilizers, cell regulators, antioxidants, cross-linkers and/or chain extenders, as well as catalysts, such as tertiary amines and/or organometallic salts and eventually flame retardant additives and/or fillers.

As a number of the materials and additives used in producing polyurethane foam can be released as volatile organic compounds (VOCs), efforts have been made to utilize additives which reduce the level of VOCs. For example, efforts have been made to reduce the level of volatile amine catalysts by utilizing amine catalysts which contain a hydrogen isocyanate reactive group, i.e. a hydroxyl or a primary and/or a secondary amine. Such catalysts are disclosed in EP 747,407. Other types of reactive monol catalysts are described in U.S. Pat. Nos. 4,122,038, 4,368,278 and 4,510,269.

Use of specific amine-initiated polyols is proposed in EP 539,819, in U.S. Pat. No. 5,672,636 and in WO 01/58,976. Polyols containing tertiary amino groups are described in U.S. Pat. No. 3,428,708, in U.S. Pat. No. 5,482,979, and in U.S. Pat. No. 4,934,579.

Another example for the reduction of VOCs is the replacement of the antioxidant BHT (Butylated Hydroxy-Toluene) with less migrating molecules such as those disclosed in EP 1,437,372.

While all of these technologies allow elimination of some VOCs from polyurethane flexible foams, surfactant used to stabilize foam cells may also contribute to the level of VOCs in the foam.

Accordingly it would be desirable to provide a flexible polyurethane foam having good properties that are made from a polyol based on a renewable resource and which further aids in the goal of reducing the level of VOCs in the foam.

It is an object of the present invention to produce flexible and/or viscoelastic, particularly one-shot polyurethane foams, without silicone based surfactant or with substantially reduced levels of silicone surfactants. It has been surprisingly found this can be achieved by the use of polyols based on renewable resources having intrinsic surfactancy.

It is also an object of the present invention to produce free-rise, slabstock or molded, flexible and/or viscoelastic polyurethane foams using polyols from renewable resources without the use of a silicone based surfactant or with a substantial reduction in the use level of such a surfactant where the compression sets meet OEM's (Original Equipment Manufacturers) specifications.

The present invention is a process for the production of a polyurethane foam by reaction of a mixture of

(a) at least one organic polyisocyanate with

(b) a polyol composition comprising

(b1) up to 99 percent by weight of at least one polyol compound other than (b2) having a nominal starter functionality of 2 to 8 and a hydroxyl number from 15 to 200, and

(b2) from 1 up to 100 percent by weight of at least one polyol based on a renewable resources with a hydroxyl number below 300 and a viscosity at 25° C. below 6,000 mPa·s,

(c) optionally in the presence of one or more polyurethane catalysts,

(d) in the presence of 0.5 to 10 parts of water per hundred parts of polyol as blowing agent; and

(e) optionally additives or auxiliary agents known per se for the production of polyurethane foams

wherein the total reaction mixture contains substantially no silicone based surfactant.

In another embodiment, the present invention is the use of a polyol from a renewable resource containing both hydrophobic and hydrophilic moieties as a surfactant for production of flexible, semi-rigid and/or viscoelastic polyurethane foam.

In another embodiment, polyol (b2) contains a high EO (ethylene oxide) based moiety.

In another embodiment, the present invention is a silicone free, flexible, semi-rigid and/or viscoelastic polyurethane foam, having a density below 80 kg/m3, made with a natural based polyol (b2).

In another embodiment, the present invention is a process whereby at least one additive (e) is a silicone free organic emulsifier and/or surfactant.

In another embodiment, the present invention is a process whereby polyol (b2) contains primary and/or secondary hydroxyl groups.

In another embodiment, the present invention is a process whereby polyol (b1) or polyol (b2) contains primary and/or secondary amine groups.

In another embodiment, the present invention is a process as disclosed above wherein the polyisocyanate (a) contains at least one polyisocyanate that is a reaction product of an excess of polyisocyanate with a polyol.

In a further embodiment, the present invention is a process as disclosed above where the polyol (b) contains a polyol-terminated prepolymer obtained by the reaction of an excess of polyol with a polyisocyanate wherein the polyol is defined by (b1) and/or (b2). Reacting an isocyanate with polyol (b2) will change its HLP balance (HLB is the hydrophilic/lipophilic balance)

The invention further provides for polyurethane products produced by any of the above processes.

The polyol (b2) based on renewable resources is also referred to herein as natural oil based polyols (NOBP). The polyols (b2) are liquid at room temperature and have multiple active sites. The addition of polyol (b2), particularly in a one-shot polyurethane reaction mixture, eliminates the need to include a silicone based surfactant in a flexible, semi-rigid and/or viscoelastic foam formulation. As used herein, substantially no silicone surfactant means the absence of a silicone based surfactant or a level of surfactant below detectable changes in the foam property measured against the properties of the foam prepared in the absence of a silicone based surfactant.

In accordance with the present invention, a process for the production of polyurethane products is provided, whereby polyurethane products of relatively low odor and low emission of VOC's are produced. This advantage is achieved by including in the polyol (b) composition a natural oil based polyol (b2). Such polyol (b2) can also be added as an additional feedstock polyol in the preparation of SAN, PIPA or PHD copolymer polyols and adding them to the polyol mixture (b). Another option is of using polyols (b2) in a prepolymer with a polyisocyanate alone or with an isocyanate and a second polyol.

As used herein the term polyols are those materials having at least one group containing an active hydrogen atom capable of undergoing reaction with an isocyanate. Preferred among such compounds are materials having at least two hydroxyls, primary or secondary, or at least two amines, primary or secondary, carboxylic acid, or thiol groups per molecule. Compounds having at least two hydroxyl groups or at least two amine groups per molecule are especially preferred due to their desirable reactivity with polyisocyanates.

Suitable polyols (b1) of the present invention are well known in the art and include those described herein and any other commercially available polyol and/or SAN, PIPA or PHD copolymer polyols. Such polyols are described in “Polyurethane Handbook”, by G. Oertel, Hanser publishers. Mixtures of one or more polyols and/or one or more copolymer polyols may also be used to produce polyurethane products according to the present invention.

Representative polyols include polyether polyols, polyester polyols, polyhydroxy-terminated acetal resins, hydroxyl-terminated amines and polyamines. Examples of these and other suitable isocyanate-reactive materials are described more fully in U.S. Pat. No. 4,394,491. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound.

Examples of suitable initiator molecules are water, organic dicarboxylic acids, such as succinic acid, adipic acid, phthalic acid and terephthalic acid; and polyhydric, in particular dihydric to octohydric alcohols or dialkylene glycols.

Exemplary polyol initiators include, for example, ethanediol, 1,2- and 1,3-propanediol, diethylene glycol, dipropylene glycol, 1,4-butanediol, 1,6-hexanediol, glycerol, pentaerythritol, sorbitol, sucrose, neopentylglycol; 1,2-propylene glycol; trimethylolpropane glycerol; 1,6-hexanediol; 2,5-hexanediol; 1,4-butanediol; 1,4-cyclohexane diol; ethylene glycol; diethylene glycol; triethylene glycol; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol; and combination thereof.

Other initiators include linear and cyclic compounds containing an amine. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine various isomers of toluene diamine; diphenylmethane diamine; N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropyl-imidazole.

Exemplary aminoalcohols include ethanolamine, diethanolamine, and triethanolamine.

Polyol (b1) can also contain a tertiary nitrogen in the chain, by using for instance an alkyl-aziridine as co-monomer with PO and EO.

Polyols with tertiary amine end-cappings are those which contain a tertiary amino group linked to at least one tip of a polyol chain. These tertiary amines can be N,N-dialkylamino, N-alkyl, aliphatic or cyclic, amines, polyamines.

Other useful initiators that may be used include polyols, polyamines or aminoalcohols described in U.S. Pat. Nos. 4,216,344; 4,243,818 and 4,348,543 and British Patent 1,043,507.

Of particular interest are poly(propylene oxide) homopolymers, random copolymers of propylene oxide and ethylene oxide in which the poly(ethylene oxide) content is, for example, from about 1 to about 30% by weight, ethylene oxide-capped poly(propylene oxide) polymers and ethylene oxide-capped random copolymers of propylene oxide and ethylene oxide. For slabstock foam applications, such polyethers preferably contain 2-5, especially 2-4, and preferably from 2-3, mainly secondary hydroxyl groups per molecule and have an equivalent weight per hydroxyl group of from about 400 to about 3000, especially from about 800 to about 1750. For high resiliency slabstock and molded foam applications, such polyethers preferably contain 2-6, especially 2-4, mainly primary hydroxyl groups per molecule and have an equivalent weight per hydroxyl group of from about 1000 to about 3000, especially from about 1200 to about 2000. When blends of polyols are used, the nominal average functionality (number of hydroxyl groups per molecule) will be preferably in the ranges specified above.

For viscoelastic foams shorter chain polyols with hydroxyl numbers above 150 are also used.

For the production of semi-rigid foams, it is preferred to use a trifunctional polyol with a hydroxyl number of 30 to 80.

The polyether polyols may contain low terminal unsaturation (for example, less that 0.02 meq/g or less than 0.01 meq/g), such as those made using so-called double metal cyanide (DMC) catalysts, as described for example in U.S. Pat. Nos. 3,278,457, 3,278,458, 3,278,459, 3,404,109, 3,427,256, 3,427,334, 3,427,335, 5,470,813 and 5,627,120. Polyester polyols typically contain about 2 hydroxyl groups per molecule and have an equivalent weight per hydroxyl group of about 400-1500. Polymer polyols of various sorts may be used as well. Polymer polyols include dispersions of polymer particles, such as polyurea, polyurethane-urea, polystyrene, polyacrylonitrile and polystyrene-co-acrylonitrile polymer particles in a polyol, typically a polyether polyol. Suitable polymer polyols are described in U.S. Pat. Nos. 4,581,418 and 4,574,137.

In one embodiment, (b1) contains at least one polyol which contains autocatalytic activity and can replace a portion or all of the amine and/or organometallic catalyst generally used in the production of polyurethane foams. Autocatalytic polyols are those made from an initiator containing a tertiary amine, polyols containing a tertiary amine group in the polyol chain or a polyol partially capped with a tertiary amine group. Generally, (b2) is added to replace at least 10 percent by weight of amine catalyst while maintaining the same reaction profile. Generally an autocatalytic polyol is added to replace at least 20 percent by weight of the conventional amine catalyst while maintaining the same reaction profile. More preferably is added to replace at least 30 percent by weight of the amine catalyst while maintaining the same reaction profile. Such autocatalytic polyols may also be added to replace at least 50 percent by weight of the amine catalyst while maintaining the same reaction profile. Alternatively, such autocatalytic polyols may be added to enhance the demold time.

Such autocatalytic polyols are disclosed in EP 539,819, in U.S. Pat. Nos. 5,672,636; 3,428,708; 5,482,979; 4,934,579 and 5,476,969 and in WO 01/58,976, the disclosure of which is incorporated herein by reference.

In one preferred embodiment, the autocatalytic polyol has a molecular weight of from about 1000 to about 12,000 and is prepared by alkoxylation of at least one initiator molecule of the formula

HₘA-(CH₂)ₙ—N(R)—(CH₂)ₚ-AHₘ Formula (I)

wherein n and p are independently integers from 2 to 6, A at each occurrence is independently oxygen, nitrogen, sulfur or hydrogen, with the proviso that only one of A can be hydrogen at one time,
R is a C₁ to C₃ alkyl group,
m is equal to 0 when A is hydrogen, is 1 when A is oxygen and is 2 when A is nitrogen, or

H₂N—(CH₂)ₘ—N—(R)—H Formula (II)

where m is an integer from 2 to 12 and
R is a C₁ to C₃ alkyl group.

Preferred initiators for the production of an autocatalytic polyol include, 3,3′-diamino-N-methyldipropylamine, 2,2′-diamino-N-methyldiethylamine, 2,3-diamino-N-methyl-ethyl-propylamine N-methyl-1,2-ethanediamine and N-methyl-1,3-propanediamine.

Generally when used, the aforementioned autocatalytic polyols will constitute up to 50 weight percent of the total polyol, preferably up to 40 weight percent of the polyol. Generally when used, such autocatalytic polyols will constitute at least 1 weight percent of the polyol. More preferably such polyols will represent 5 percent of greater of the total polyol.

Autocatalytic polyols containing at least one imine linkage and one tertiary amine group as disclosed in WO Publication 2005063840, the disclosure of which is incorporated herein by reference may also be used. In general such polyols are based on the reaction between an aldehyde, or a ketone, and a molecule containing both primary amine and tertiary amine groups. When such imine based polyols are used, they will generally constitute from 0.5 to 2 parts of the polyol component. A combination of the autocatalytic polyols may also be used.

Polyols of (b2) are polyols based on or derived from renewable resources such as natural and/or genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, sunflower seed oils, or a combination thereof. Examples of animal products include lard, beef tallow, fish oils and mixtures thereof. A combination of vegetable and animal based oils/fats may also be used. The iodine value of these natural oils range from about 40 to 240. Preferably polyols (b2) are derived from soybean and/or castor and/or canola oils.

For use in the production of flexible polyurethane foam it is generally desirable to modify the natural materials to give the material isocyanate reactive groups or to increase the number of isocyanate reactive groups on the material. Preferably such reactive groups are a hydroxyl group. Several chemistries can be used to prepare the polyols of (b2). Such modifications of a renewable resource include, for example, epoxidation, as described in U.S. Pat. No. 6,107,433 or in U.S. Pat. No. 6,121,398; hydroxylation, such as described in WO 2003/029182; esterification such as described in U.S. Pat. No. 6,897,283; 6,962,636 or 6,979,477; hydroformylation as described in WO 2004/096744; grafting such as described in U.S. Pat. No. 4,640,801; or alkoxylation as described in U.S. Pat. No. 4,534,907 or in WO 2004/020497. The above cited references for modifying the natural products are incorporated herein by reference. After the production of such polyols by modification of the natural oils, the modified products may be further alkoxylated. The use of EO or mixtures of EO with other oxides, introduce hydrophilic moieties into the polyol. In one embodiment, the modified product undergoes alkoxylation with sufficient EO to produce a polyol (b2) with from 10 to 60 weight percent EO; preferably 20 to 40 weight percent EO

In another embodiment, the polyols (b2) are obtained by a combination of the above modification techniques as disclosed in PCT Publications WO 2004/096882 and 2004/096883, and Applicant's co-pending application Ser. No. 60/676,348 entitled “Polyester Polyols Containing Secondary alcohol Groups and Their Use in Making Polyurethanes Such as Flexible Polyurethane Foams”, the disclosures of which are incorporated herein by reference. In brief, the process involves a multi-step process wherein the animal or vegetable oils/fats is subjected to transesterification and the constituent fatty acids recovered. This step is followed by hydroformylating carbon-carbon double bonds in the constituent fatty acids to form hydroxymethyl groups, and then forming a polyester or polyether/polyester by reaction of the hydroxymethylated fatty acid with an appropriate initiator compound. This later technologies is favored since as it allows the production of a polyol (b2) with both hydrophobic and hydrophilic moieties. The hydrophobic moiety is provided by the natural oils since those contain C4 to C24 saturated and/or unsaturated chain lengths, preferably C4 to C18 chain lengths, while the hydrophilic moiety is obtained by the use of proper polyol chains present on the initiator, such as those containing high levels of ethylene oxide.

The initiator for use in the multi-step process for the production of polyol (b2) may be any of the initiators given above used in the production of polyol (b1).

Preferably the initiator is selected from the group consisting of neopentylglycol; 1,2-propylene glycol; trimethylolpropane; pentaerythritol; sorbitol; sucrose; glycerol; diethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol; hydrogenated bisphenol; 9,9(10,10)-bishydroxymethyloctadecanol; 1,2,6-hexanetriol and combination thereof.

More preferably the initiator is selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof.

Most preferably the initiator is glycerol, trimethylpropane, pentaerythritol, sucrose, sorbitol, and/or mixture thereof.

In one preferred embodiment, such initiators are alkoxylated with ethylene oxide or a mixture of ethylene and at least one other alkylene oxide to give an alkoxylated initiator with a molecular weight of 200 to 6000, especially from 400 to 2000. Preferably the alkoxylated initiator has a molecular weight from 500 to 1000.

In one embodiment, polyol (b2) contains from 10 to 60 weight percent ethylene oxide. Preferably polyol (b2) will contain from 15 to 50 weight percent EO. More preferably polyol (b2) contains from 20 to 40 weight percent ethylene oxide.

The functionality of polyol (b2), or blend of such polyols, is above 1.5 and generally not higher than 6. Preferably the functionality is below 4. The hydroxyl number of polyol (b2), or blend of such polyols, is below 300 mg KOH/g, and preferably below 100.

Polyol (b2) can constitute up to 100 weight percent of polyol formulation. However this is not preferred for flexible foam. Usually polyol (b2) constitutes at least 5%, at least 10%, at least 25%, at least 35%, or at least 50% of the total weight of the polyol component. Although not preferred, polyol (b2) may constitute 75% or more, 85% or more, 90% or more, 95% or more or even 100% of the total weight of the polyol.

Combination of two types of polyols (b2) can also be used, either to maximize the level of seed oil in the foam formulation, or to optimize foam processing and/or specific foam characteristics, such as resistance to humid aging.

The viscosity of the polyol (b2) measured at 25° C. is generally less than 6,000 mPa·s. Preferably the viscosity of polyol (b2) at 25° C. is less than 5,000 mPa·s.

Isocyanates which may be used in the present invention include aliphatic, cycloaliphatic, arylaliphatic and aromatic isocyanates. Aromatic isocyanates are preferred.

Examples of suitable aromatic isocyanates include the 4,4′-, 2,4′ and 2,2′-isomers of diphenylmethane diisocynate (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyanates. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used. MDI or TDI based prepolymers can also be used, made either with polyol (b1), polyol (b2) or any other polyol as described heretofore. Isocyanate-terminated prepolymers are prepared by reacting an excess of polyisocyanate with polyols, including aminated polyols or imines/enamines thereof, or polyamines.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

For the production of flexible foams, the preferred polyisocyanates are the toluene-2,4- and 2,6-diisocyanates or MDI or combinations of TDI/MDI or prepolymers made therefrom.

Isocyanate tipped prepolymer based on polyol (b2) can also be used in the polyurethane formulation.

The amount of polyisocyanate used in making the flexible foam is commonly expressed in terms of isocyanate index, i.e. 100 times the ratio of NCO groups to reactive hydrogens-contained in the reaction mixture. In the production of conventional slabstock foam, the isocyanate index typically ranges from about 75-140, especially from about 80 to 115. In molded and high resiliency slabstock foam, the isocyanate index typically ranges from about 50 to about 150, especially from about 75 to about 110.

One or more crosslinkers may be present in the flexible foam formulation, in addition to the polyols described above. This is particularly the case when making high resilience slabstock or molded foam. If used, suitable amounts of crosslinkers are from about 0.1 to about 1 part by weight, especially from about 0.25 to about 0.5 part by weight, per 100 parts by weight of polyols.

For purposes of this invention “crosslinkers” are materials having three or more isocyanate-reactive groups per molecule and an equivalent weight per isocyanate-reactive group of less than 400. Crosslinkers preferably contain from 3-8, especially from 3-4 hydroxyl, primary amine or secondary amine groups per molecule and have an equivalent weight of from 30 to about 200, especially from 50-125. Examples of suitable crosslinkers include diethanol amine, monoethanol amine, triethanol amine, mono- di- or tri(isopropanol) amine, glycerine, trimethylol propane, pentaerythritol, sorbitol and the like.

It is also possible to use one or more chain extenders in the foam formulation. For purposes of this invention, a chain extender is a material having two isocyanate-reactive groups per molecule and an equivalent weight per isocyanate-reactive group of less than 400, especially from 31-125. The isocyanate reactive groups are preferably hydroxyl, primary aliphatic or aromatic amine or secondary aliphatic or aromatic amine groups. Representative chain extenders include amines ethylene glycol, diethylene glycol, 1,2-propylene glycol, dipropylene glycol, tripropylene glycol, ethylene diamine, phenylene diamine, bis(3-chloro-4-aminophenyl)methane and 2,4-diamino-3,5-diethyl toluene. If used, chain extenders are typically present in an amount from about 1 to about 50, especially about 3 to about 25 parts by weight per 100 parts by weight high equivalent weight polyol.

The use of such crosslinkers and chain extenders is known in the art as disclosed in U.S. Pat. No. 4,863,979 and EP Publication 0 549 120.

In utilizing the NOBP in the present invention, a polyether polyol may be included in the formulation, i.e, as part of polyol (b1), to promote the formation of an open-celled or softened polyurethane foam. Such cell openers are disclosed in U.S. Pat. No. 4,863,976, the disclosure of which is incorporated here by reference. Such cell openers generally have a functionality of 2 to 12, preferably 3 to 8, and a molecular weight of at least 5,000 up to about 100,000. Such polyether polyols contains at least 50 weight percent oxyethylene units, and sufficient oxypropylene units to render it compatible with the components. The cell openers, when used, are generally present in an amount from 0.2 to 5, preferably from 0.2 to 3 parts by weight of the total polyol. Examples of commercially available cell openers are VORANOL*Polyol CP 1421 and VORANOL* Polyol 4053; VORANOL is a trademark of The Dow Chemical Company.

For producing a polyurethane-based foam, a blowing agent is generally required. In the production of flexible polyurethane foams, water is preferred as a blowing agent. The amount of water is preferably in the range of from 0.5 to 10 parts by weight, more preferably from 2 to 7 parts by weight based on 100 parts by weight of the polyol. Carboxylic acids or salts are also used as reactive blowing agents. Other blowing agents can be liquid or gaseous carbon dioxide, methylene chloride, acetone, pentane, isopentane, methyl or dimethoxymethane, dimethylcarbonate. Use of artificially reduced or increased atmospheric pressure can also be contemplated with the present invention.

In addition to the foregoing critical components, it is often desirable to employ certain other ingredients in preparing polyurethane polymers. Among these additional ingredients are emulsifiers, preservatives, flame retardants, colorants, antioxidants, reinforcing agents, fillers, including recycled polyurethane foam in form of powder.

While the formulations do not include a silicone surfactant, an emulsifier is generally added to help compatibilize the reaction components. Such emulsifiers are known in the art and examples of non silicone based emulsifier include sulfonated natural oils, fatty acid esters and ethylene oxide condensates of phenol or octylphenol. Examples of commercially available emulsifiers include Span 80, a sorbitan monooleate, and sodium salts of sulfonated ricinoleic acid. When used, the emulsifier is generally from 0.1 to 10 weight percent of the total polyol, more preferably from 1 to 8 parts and even more preferably from 2 to 6 percent.

In utilizing the NOPB in the present invention, a high functionality polyether polyol may be included in the formulation to promote the formation of an open-celled or softened polyurethane foam. Such cell openers are disclosed in U.S. Pat. No. 4,863,976, the disclosure of which is incorporated here by reference. Such cell openers generally have a functionality of 4 to 12, preferably 5 to 8, and a molecular weight of at least 5,000 up to about 100,000. Such polyether polyols contains at least 50 weight percent oxyethylene units, and sufficient oxypropylene units to render it compatible with the components. The cell openers, when used, are generally present in an amount from 0.2 to 5, preferably from 0.2 to 3 parts by weight of the total polyol.

One or more catalysts for the reaction of the polyol (and water, if present) with the polyisocyanate can be used. Any suitable urethane catalyst may be used, including tertiary amine compounds, amines with isocyanate reactive groups and organometallic compounds. Exemplary tertiary amine compounds include triethylenediamine, N-methylmorpholine, N,N-dimethylcyclohexylamine, pentamethyldiethylenetriamine, tetramethylethylenediamine, bis(dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. The amount of amine catalysts can vary from 0.02 to 5 percent in the formulation or organometallic catalysts from 0.001 to 1 percent in the formulation can be used.

The applications for foams produced by the present invention are those known in the industry. Flexible, semi-rigid and viscoelastic foams find use in applications such as furniture, shoe soles, automobile seats, sun visors, steering wheels, packaging applications, armrests, door panels, noise insulation parts, other cushioning and energy management applications, carpet backing, dashboards and other applications for which conventional flexible polyurethane foams are used.

Processing for producing polyurethane products are well known in the art. In general components of the polyurethane-forming reaction mixture may be mixed together in any convenient manner, for example by using any of the mixing equipment described in the prior art for the purpose such as described in “Polyurethane Handbook”, by G. Oertel, Hanser publisher.

In general, the polyurethane foam is prepared by mixing the polyisocyanate and polyol composition in the presence of the blowing agent, catalyst(s) and other optional ingredients as desired, under conditions such that the polyisocyanate and polyol composition react to form a polyurethane and/or polyurea polymer while the blowing agent generates a gas that expands the reacting mixture. The foam may be formed by the so-called prepolymer method, as described in U.S. Pat. No. 4,390,645, for example, in which a stoichiometric excess of the polyisocyanate is first reacted with the high equivalent weight polyol(s) to form a prepolymer, which is in a second step reacted with a chain extender and/or water to form the desired foam. Frothing methods, as described in U.S. Pat. Nos. 3,755,212; 3,849,156 and 3,821,130, for example, are also suitable. So-called one-shot methods, such as described in U.S. Pat. No. 2,866,744, are preferred. In such one-shot methods, the polyisocyanate and all polyisocyanate-reactive components are simultaneously brought together and caused to react. Three widely used one-shot methods which are suitable for use in this invention include slabstock foam processes, high resiliency slabstock foam processes, and molded foam methods.

Slabstock foam is conveniently prepared by mixing the foam ingredients and dispensing them into a trough or other region where the reaction mixture reacts, rises freely against the atmosphere (sometimes under a film or other flexible covering) and cures. In common commercial scale slabstock foam production, the foam ingredients (or various mixtures thereof) are pumped independently to a mixing head where they are mixed and dispensed onto a conveyor that is lined with paper or plastic. Foaming and curing occurs on the conveyor to form a foam bun. The resulting foams are typically from about from about 10 kg/m³ to 80 kg/m³, especially from about 15 kg/m³ to 60 kg/m³, preferably from about 17 kg/m³ to 50 kg/m³ in density.

A preferred slabstock foam formulation contains from about 3 to about 6, preferably about 4 to about 5 parts by weight water are used per 100 parts by weight high equivalent weight polyol at atmospheric pressure. At reduced pressure these levels are reduced.

High resilience slabstock (HR slabstock) foam is made in methods similar to those used to make conventional slabstock foam but using higher equivalent weight polyols. HR slabstock foams are characterized in exhibiting a Ball rebound score of 45% or higher, per ASTM 3574.03. Water levels tend to be from about 2 to about 6, especially from about 3 to about 5 parts per 100 parts (high equivalent) by weight of polyols.

Molded foam can be made according to the invention by transferring the reactants (polyol composition including copolyester, polyisocyanate, blowing agent, and surfactant) to a closed mold where the foaming reaction takes place to produce a shaped foam. Either a so-called “cold-molding” process, in which the mold is not preheated significantly above ambient temperatures, or a “hot-molding” process, in which the mold is heated to drive the cure, can be used. Cold-molding processes are preferred to produce high resilience molded foam. Densities for molded foams generally range from 30 to 50 kg/m³.

The following examples are given to illustrate the invention and should not be interpreted as limiting in anyway. Unless stated otherwise, all parts and percentages are given by weight.

A description of the raw materials used in the examples is as follows.
DEOA is 99% pure diethanolamine.
Dabco 33 LV is a tertiary amine catalyst available from Air Products and Chemicals Inc.
Niax A-1 is a tertiary amine catalyst available from GE Specialties.
Niax A-300 is a tertiary amine catalyst available from GE Specialties.
Cosmos 29 is Stannous Octoate catalyst available from Degussa-Goldschmidt.
Span 80 is sorbitan monooleate emulsifier available from Aldrich.
Tegostab B-9719 LF is a silicone based surfactant available from Degussa-Goldschmidt.
SPECFLEX NC 632 is a 1,700 EW polyoxypropylene polyoxyethylene polyol initiated with a blend of glycerol and sorbitol available from The Dow Chemical Company.
SPECFLEX NC-700 is a 40 percent SAN based copolymer polyol with an average hydroxyl number of 20 available from The Dow Chemical Company.
Voralux HF 505 is a sorbitol initiated polyol having a hydroxyl number of 29, available from The Dow Chemical Company.
Voralux HN 380 is a styrene-acrylonitrile based copolymer polyol having a hydroxyl number of 29, available from The Dow Chemical Company.
Voranol CP 1421 is a glycerine initiated polyol having a hydroxyl number of 34, available from The Dow Chemical Company
Polyol A is a 1,700 equivalent weight propoxylated tetrol initiated with 3,3′-diamino-N-methyl-dipropylamine and capped with 20% ethylene oxide.
Polyol B is the reaction product of D.E.R. 732 epoxy resin, available from the Dow Chemical company, salicylaldehyde, and 3-(N,N-dimethylamino)propylamine, as described in WO 05/063840.
VORANATE T-80 is TDI 80/20 (2,4-/2,6-isomers) isocyanate available from The Dow Chemical Company.
Isonate M-229 is a MDI polymeric isocyanate available from The Dow Chemical Company.
NOBP A is a soybean oil based polyol prepared according to examples 19-22 of WO 2004/096882 having an OH number of 56.
NOBP B is a soybean oil based polyol prepared according to examples 19-22 of WO 2004/096882 having an OH number of 88 and a viscosity of 1,900 mPa·s at 25° C.

All foams are made in the laboratory by preblending polyols, surfactants if needed, crosslinkers, catalysts and water, conditioned at 25° C. Isocyanate is also conditioned at 25° C. Bench made foam is made by hand-mixing and machine made foam is produced using a high pressure impingement mix-head equipped KM-40 from Krauss-Maffei. The mold release agent is Kluber 41-2013, available from Chem-Trend.

Continuous slabstock foam was produced with a Polymech machine equipped with separate streams for polyols, water, catalysts and isocyanate.

Foam properties are measured according to ASTM D 3574-83 test methods, unless otherwise indicated.

Bench free rise reactivity and density are recorded by pouring the reactant in a bucket and letting the foam rise without any constraint.

### EXAMPLES 1 AND 2

Production of semi-rigid foams with viscoelastic characteristics are prepared by hand-mixing using the following formulations in Table 1:

TABLE 1

| Example | 1 | 2 |
|---|---|---|
| NOBP A | 100 | 100 |
| Water | 3.3 | 3.3 |
| Dabco 33 LV | 0.1 | 0.1 |
| Span 80 | 0 | 5 |
| Isonate M-229 | 63 | 63 |
| Foam density (kg/m3) | 65 | 65 |
| Cell structure | Regular | Regular |

These foams are crushed before cooling. The foam of example 2 is more open. The results show that a foam can be produced having a good cell structure in the absence of a silicone surfactant, eventually using an emulsifier (Span 80) to open the foam.

### EXAMPLE 3

A flexible polyurethane foam of low density is produced in a 20 liter plastic bucket using a high pressure KM-40 machine and the formulation in Table 2. Without the presence of a silicone surfactant and using NOBP B instead, good foam is obtained with the formulation of Table 2.

TABLE 2

| Example | 3 |
|---|---|
| Specflex NC 632 | 50 |
| Specflex NC 700 | 10 |
| NOBP B | 40 |
| Water | 3.5 |
| DEOA | 0.7 |
| Niax A-1 | 0.05 |
| Dabco 33 LV | 0.30 |
| Niax A-300 (50% water) | 0.1 |
| Voranate T-80 index | 100 |
| Cream time (s) | 8-10 |
| Gel time (s) | 80 |
| Rise time (s) | 140 |
| Settling | No |
| Foam density (kg/m3) | 24.5 |
| Ball Resiliency (%) | 45 |

The results show the foam produced in the absence of a silicone surfactant has acceptable properties. The foam has an irregular cell structure, typical of HR foam, and does not show any “finger nailing”, i.e. marks under squeezing with sharp objects, after curing. Foam periphery is stable, no basal cells present.

### EXAMPLE 4

A foam is prepared as per Example 3 where the polyol blend is maintained under stirring in a machine tank overnight. The foam properties are comparable to those of Example 3 indicating the NOBP system, which contains ester groups, is stable in the presence of water and amines.

### EXAMPLES 5 AND COMPARATIVE 1C

Molded foams are produced in a 400×400×115 mm aluminium mold, heated at 60° C., equipped with vent-holes using the formulations in Table 3.

TABLE 3

| Example | 5 | 1C |
|---|---|---|
| NOBP B | 20 | 0 |
| Specflex NC 700 | 10 | 30 |
| Specflex NC 632 | 70 | 70 |
| Tegostab B 8719 LF | 0 | 0.6 |
| Water | 3.5 | 3.5 |
| DEOA | 0.7 | 0.7 |
| Niax A-1 | 0.05 | 0.05 |
| Dabco 33 LV | 0.30 | 0.30 |
| Niax A-300 | 0.1 | 0.1 |
| Voranate T-80 index | 105 | 105 |
| Core density (kg/m3) | 37.9 | 38.0 |
| 40% IFD (N) | 293 | 342 |
| Tensile str (KPa) | 111 | 140 |
| Elongation (%) | 188 | 101 |
| Tear str (N/m) | 217 | 272 |
| Airflow (cfm) | 4.6 | 3.4 |
| 75% Compression set (%) | 11 | 12.8 |
| Peugeot dynamic fatigue | | |
| Height loss (%) | 4.1 | 3.2 |
| Load loss (%) | 10.5 | 12.5 |

1C is a comparative example, not part of this invention

The foam core is free of densification or collapse, even under the vent-holes, while the bottom surface of the part shows a 5 mm layer of coarse cells, believed to be due to incompatibility with the release agent. At 20 parts of NOBP, the air flow, compression set and elongation properties of foams are good and the other properties are within industrially accepted ranges. Demolding time was 5 min for the foam of Example 5.

### COMPARATIVE EXAMPLE 2C

Free rise foam made with comparative formulation 1C shows heavy collapse and unstability when the silicone surfactant Tegostab B 8719 LF is omitted.

### EXAMPLES 6

A formulation utilizing an autocatalytic polyol and NOBP as given in Table 4 are used to make a flexible free rise foam. The formulation does not contain a silicone surfactant or conventional amine catalyst.

TABLE 4

| | Example 6 |
|---|---|
| Specflex NC 632 | 20 |
| NOPB B | 50 |
| Polyol A | 30 |
| Polyol B | 1.5 |
| Water | 3.5 |
| DEOA | 1.0 |
| Voranate T 80 index | 100 |
| Cream time (s) | 6 |
| Gel time (s) | 90 |
| Rise time (s) | 100 |
| Core density (kg/m3) | 29.2 |

### EXAMPLE 7

A slabstock continuous foam run was carried out using a Polymech machine. Formulation and processing conditions were as follows:

| VORALUX HF 505 | 45 | |
|---|---|---|
| NOBP B | 30 | |
| VORALUX HN 380 | 25 | |
| VORANOL CP 1421 | 3 | |
| Water | 1.83 | |
| Niax A-1 | 0.15 | |
| DEOA | 0.2 | |
| Cosmos 29 | 0.06 | |
| Voranate T-80 | 25.6 | |
| Index | 105 | |
| Polyol output | 20 | kg/mn |
| Conveyer Speed | 2.5 | m/mn |
| Conveyer width | 80 | cm |
| Final block height | 35 | cm |
| Rise time | 160 | s |

| | |
|---|---|
| Foam density (kg/m3) | 44.5 |

Example 7 shows that good flexible foam can be produced with NOBP B and without silicone surfactant.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A process for the production of a polyurethane product by reaction of a mixture of
(a) at least one organic polyisocyanate with
(b) a polyol composition comprising
(b1) up to 99 percent by weight of at least one polyol compound having a nominal starter functionality of 2 to 8 and a hydroxyl number from 15 to 800, and
(b2) from 1 to 100 percent by weight of at least one natural oil based polyol with a hydroxyl number below 300 and a viscosity at 25° C. below 6,000 mPa·s
(c) optionally in the presence of one or more polyurethane catalysts,
(d) in the presence of a blowing agent; and
(e) optionally additives or auxiliary agents known per se for the production of polyurethane foams
wherein the total reaction mixture contains substantially no silicone based surfactants.

2. The process of claim 1 wherein (b2) is from 30 to 85 percent by weight of the total polyol.

3. The process of claim 1 wherein the polyisocyanate component comprises at least 60 weight percent or greater of toluene diisocyanate polyisocyanate.

4. The process of claim 1 wherein the polyisocyanate component comprises a mixture of toluene diisocyanate and methylene diisocyanate.

5. The process of claim 1 wherein (b1) contains at least one polyol containing a tertiary amine group in the polyol chain, a polyol initiated with an initiator containing a tertiary amine or a polyol partially capped with a tertiary amine group.

6. The process of claim 5 wherein the polyol containing a tertiary amine comprises from 1 to 50 weight percent of the total polyol.

7. The process of claim 6 wherein the polyol containing a tertiary amine comprises from 5 to 40 weight percent of the total polyol.

8. The process of claim 5 wherein the initiator containing a tertiary amine is at least one initiator of Formula I
HₘA-(CH₂)ₙ—N(R)—(CH₂)ₚ-AHₘ Formula (I)
wherein n and p are independently integers from 2 to 6,
A at each occurrence is independently oxygen, nitrogen, sulphur or hydrogen, with the proviso that only one of A can be hydrogen at one time,
R is a C₁ to C₃ alkyl group,
m is equal to 0 when A is hydrogen, is 1 when A is oxygen and is 2 when A is nitrogen, or Formula II
H₂N—(CH₂)ₘ—N—(R)—H Formula (II)
where m is an integer from 2 to 12 and
R is a C₁ to C₃ alkyl group.

9. The process of claim 8 wherein the initiator is at least one of 3,3′-diamino-N-methyldipropylamine, 2,2′-diamino-N-methyldiethylamine, 2,3-diamino-N-methyl-ethylpropylamine N-methyl-1,2-ethanediamine and N-methyl-1,3-propanediamine.

10. The process of claim 1 wherein (b1) contains at least one polyol containing at least one imine linkage and one tertiary amine.

11. The process of claim 10 wherein the polyol of claim 10 comprises from 0.5 to 2 weight percent of the total polyol.

12. The process of claim 1 wherein (b1) contains a SAN, PIPA or PHD grafted polyol.

13. The process of claim 1, wherein the natural oil based polyol is derived from natural oils of castor, soybean, olive, peanut, rapeseed, corn, sesame, cotton, canola, safflower, linseed, palm, sunflower seed oils, or a combination thereof.

14. The process of claim 13 wherein in the natural oil based polyol is derived from a castor oil, soybean oil or a combination thereof.

15. The process of claim 13 wherein the natural oil based polyol contains from 10 to 50 weight percent of ethylene oxide.

16. The process of claim 15 wherein the polyol is derived from a natural oil which is treated by epoxidation, hydroxylation, esterification, hydroformylation, or a combination thereof, followed by reaction with an ethylene oxide or a mixture of ethylene oxide and at least one other alkylene oxide.

17. The process of 13 wherein the natural base polyol is derived from a natural oil based polyol by the steps of transesterification of the natural oil, recovery of the constituent fatty acids, hydroformylation of the fatty acids to form hydroxymethyl group, and then formation of a polyol by reaction of the hydroxymethylated fatty acid with an initiator compound having 2 to 8 active hydrogen atoms.

18. The process of claim 17 wherein the initiator is glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; or combination thereof.

19. The process of claim 1 wherein the polyol contains from 0.2 to 3 parts by weight of the total polyol of a polyol with a nominal functionality of 4 to 12, a molecular weight from 5,000 to 100,000 wherein such polyol contains at least 50 weight percent oxyethylene units.

20. The process of any of the preceding claims claim 1 wherein the reaction mixture contains from 0.1 to 10 weight percent of an emulsifier.

21. A polyurethane foam comprising the reaction product of a reaction mixture, wherein the reaction mixture comprises:
(a) at least one organic polyisocyanate;
(b) a polyol composition comprising
(b1) up to 99 percent by weight of at least one polyol compound having a nominal starter functionality of 2 to 8 and a hydroxyl number from 15 to 800, and
(b2) from 1 to 100 percent by weight of at least one natural oil based polyol with a hydroxyl number below 300 and a viscosity at 25° C. below 6,000 mPa·s; and
wherein the reaction mixture contains substantially no silicone based surfactants.

22. The foam of claim 21 wherein the polyol (b1) contains at least one polyol having a functionality of 2 to 6 and an equivalent weight per hydroxyl group of from 1,000 to 3,000.

23. The foam of claim 22 wherein the polyol contains at least 30 percent primary hydroxyl groups.
